(19) United States
(12) Patent Application Publication
(10) Pub. No.: US 2013/0297232 A1
(43) Pub. Date: Nov. 7, 2013

(54) METHOD AND DEVICE FOR INSPECTING AN OBJECT FOR THE DETECTION OF SURFACE DAMAGE

(71) Applicants: Helmuth Euler, Vaterstetten (DE); Frank Forster, Munchen (DE); Christian Homma, Vaterstetten (DE); Claudio Laloni, Taufkirchen (DE)

(72) Inventors: Helmuth Euler, Vaterstetten (DE); Frank Forster, Munchen (DE); Christian Homma, Vaterstetten (DE); Claudio Laloni, Taufkirchen (DE)

(21) Appl. No.: 13/976,210

(22) PCT Filed: Jan. 16, 2012
(86) PCT No.: PCT/EP2012/050570

§ 371 Date: Jun. 26, 2013

(30) Foreign Application Priority Data
Jan. 26, 2011 (DE) 10 2011 003 209.6

(51) Int. Cl. G01N 21/95

(52) U.S. Cl. CPC G01N 21/95
USPC 702/40

(57) ABSTRACT

A method and device for performing the method of inspecting an object for the purpose of detecting defective surface regions of the object, comprising the steps of using a scanning device to survey a surface of the object to be inspected and generating two-dimensional image data and a measured surface profile in at least one cross-sectional plane through the object in each case; using a computer device to evaluate the two-dimensional image data in order to localize a potentially defective surface region; using the computer device to generate a calculated surface profile within the potentially defective surface region in the cross-sectional plane on the basis of the measured surface pro-file outside of the potentially defective surface region of the cross-sectional plane; using the computer device to compare the calculated and measured surface profiles within the potentially defective surface region, the localized surface region being assessed as actually defective if defined differentiating features are present.

### CROSS REFERENCE TO RELATED APPLICATIONS

This application is the US National Stage of International Application No. PCT/EP2012/050570, filed Jan. 16, 2012 and claims the benefit thereof. The International Application claims the benefits of German application No. 102011003209.6 filed Jan. 26, 2011, both of the applications are incorporated by reference herein in their entirety.

### FIELD OF INVENTION

The present invention relates to a method and a device for inspecting an object for the purpose of detecting defective surfaces of the object.

### BACKGROUND OF INVENTION

For example, a coating on gas turbine blades, known as a “thermal barrier coating” (TBC) tends to debond after a relatively long period of use. This is referred to as “TBC loss”, i.e. TBC erosion. During an inspection of three-dimensional objects that have been in use and are to be reused, blades of the aforesaid type being examples thereof, it is important to detect and document defects of said kind.

In conventional practice an inspection is carried out based on visual inspection by human operatives. In this case the results are either documented in writing or stored manually with the aid of software in a database of three-dimensionally scanned objects, in particular turbine blades.

Determining TBC loss simply by means of a camera supplying conventional two-dimensional images proves difficult, since with such a method it is hard to differentiate between simply soiling or contaminants and TBC erosion.

Using a pure three-dimensional model for comparison with a CAD (Computer Aided Design) model on which the production of an object is based, i.e. a model for producing the object, in particular a blade, by means of computer support is just as difficult due to a need to survey an overall geometry of the object, which geometry is composed of different views and can be complex. Furthermore, in a pure examination of a scanned 3D model for damage, in other words without using a CAD model, it is not possible to differentiate between surface features and delaminations. In conventional practice an original CAD model is not available in every case.

### SUMMARY OF INVENTION

It is the object of the present invention to provide a method and a device for inspecting an object, in particular a turbine blade, for the purpose of detecting surface damage in such a way that defects in a surface of the object can be identified quickly, easily and reliably. It is furthermore aimed to provide a fully automatic inspection that is independent of human factors. It is also aimed to be able to document detected defects easily and automatically.

The object is achieved by means of a method as claimed in the main claim and a device as claimed in the coordinated independent claim.

According to a first aspect, a method for inspecting an object for the purpose of detecting defective surface regions of the object is provided, the method comprising the following steps of:

using a scanning device for surveying a surface of the object that is to be inspected and generating two-dimensional image data and a measured surface profile in at least one cross-sectional plane through the object in each case;
using a computer device for evaluating the two-dimensional image data in order to localize a potentially defective surface region;
using the computer device for generating a calculated surface profile within the possibly or potentially defective surface region in the cross-sectional plane on the basis of the measured surface profile outside of the possibly defective surface region of the cross-sectional plane;
using the computer device for comparing the calculated and measured surface profiles within the potentially defective surface region, the localized surface region being assessed as actually defective if defined differentiating features are present. A defined differentiating feature can be for example the average distance of a calculated from a measured surface region. If the average distance exceeds a threshold, a defined differentiating feature is present.

According to a second aspect, a device for performing a method according to the invention is provided, the device comprising a scanning device for surveying a surface of the object that is to be inspected and generating two-dimensional image data and a measured surface profile in at least one cross-sectional plane through the object in each case; a computer device for evaluating the two-dimensional image data in order to localize a potentially defective surface region; the computer device for generating a calculated surface profile within the potentially defective surface region in the cross-sectional plane on the basis of the measured surface profile outside of the potentially defective surface region of the cross-sectional plane; the computer device for comparing the calculated and the measured surface profiles within the potentially defective surface region, the localized surface region being assessed as actually defective if significant differences are present.

It has been recognized that the object according to the invention is achieved by a combination of two-dimensional and three-dimensional information and a corresponding evaluation. Two-dimensional information is in particular two-dimensional image data. Two-dimensional information can also be a surface profile in a cross-sectional plane through the object. Three-dimensional information is surface profiles in at least two mutually parallel cross-sectional planes through the object. Surface profile denotes not only the material profile of the object surface in a cross-sectional plane, but can also include a profile of any physical variables that characterize the surface of the object. Physical variables of said kind can be for example a reflection factor or a temperature.

The present solution enables the development of automatic defect detection, in particular automatic TBC loss detection for a profile of a gas turbine blade. Support can furthermore be provided to inspection personnel who conventionally mark for example TBC loss manually, either on a sheet of paper or by means of marking software. The support can take the form of automatic marking of indications of defective surface regions of an object. Alternatively an inspecting operative can manually supplement or correct results on a computer device. Furthermore, foundations are laid for other different and improved automatic inspection methods. The present invention overcomes the difficulties whereby a surface condition, on a blade for example, is not uniform. The present invention overcomes the difficulties of finding candidates, which is to say defective locations, in regions that have been exposed for a long time to particularly intense heat and consequently are black over an extensive area. In other words, regions subject to extreme thermal stress in particular are difficult to inspect. It is furthermore aimed to prevent dark, soiled locations being marked as defect sites, in particular sites subject to TBC loss. Moreover, the present invention overcomes the difficulty that cooling orifices look similar in terms of three-dimensional and two-dimensional information to TBC loss in that the locations of cooling air holes are input into a computer device.

An inspection of an object, in particular a turbine blade, for TBC loss can now be executed in its entirety either fully automatically or semi-automatically. In terms of human factors this makes possible a more independent and/or faster inspection with automatic documentation.

Other advantageous embodiments are claimed in conjunction with the dependent claims.

According to an advantageous embodiment the two-dimensional image data and the measured surface profiles of the object can be calibrated with respect to one another. In this way precisely the two-dimensional image data and surface profile data relating to the object is present for each surface region corresponding to the calibration.

According to another advantageous embodiment the two-dimensional image data can be color images. In this way a multiplicity of information about the object is provided.

According to another advantageous embodiment the two-dimensional image data can be evaluated by means of filter operations. A lowpass filter can be used for this purpose for example.

According to another advantageous embodiment one filter operation can entail analyzing a color channel and/or a saturation. In this way delaminations for example can be visualized in a particularly high-contrast manner relative to their environment or surrounding regions.

According to another advantageous embodiment calculated surface profiles of the potentially defective surface region can be generated by means of an interpolation method.

According to another advantageous embodiment the interpolation can be carried out along a scan line in the cross-sectional plane through the potentially defective surface region and on the basis of the measured surface profile along said scan line in the region outside of the potentially defective surface region. A surface profile can be represented in the two-dimensional space such that functions in relation to the profile along the object surface in the two-dimensional space can be interpolated two-dimensionally for the potentially defective surface region.

According to another advantageous embodiment boundary lines around surface regions assessed as defective can be indicated by means of a display device, or a printer device in the case of printed result images. In this way the results of the inspection can be easily visualized.

According to another advantageous embodiment the data of the inspected object can be stored by means of a storage device. In this way results of the inspection can be easily documented.

According to another advantageous embodiment the computer device can be used to remove data of an object background by means of the measured surface profiles. In this way the volume of data that is to be processed can be effectively reduced.

According to another advantageous embodiment the scanning device can be used for repeatedly recording the surface of the entire object moved by means of a rotating and/or swiveling unit.

### BRIEF DESCRIPTION OF THE DRAWINGS

The present invention is described in more detail with reference to exemplary embodiments taken in conjunction with the figures, in which:

FIG. 1 shows an exemplary embodiment of a method according to the invention;

FIG. 2 shows an exemplary embodiment of a device according to the invention;

FIG. 3a shows a plan view onto a potentially defective surface region;

FIG. 3b shows a cross-section of the potentially defective surface region represented with the aid of a measured surface profile;

FIG. 3c shows the cross-section of the potentially defective surface region with an interpolated surface profile;

FIG. 3d represents the comparison of the measured and the calculated surface profiles;

FIG. 4 shows a further processing operation on a result image according to the invention;

FIG. 5 shows an exemplary embodiment of a result image; and

FIG. 6 shows another exemplary embodiment of a result image.

### DETAILED DESCRIPTION OF INVENTION

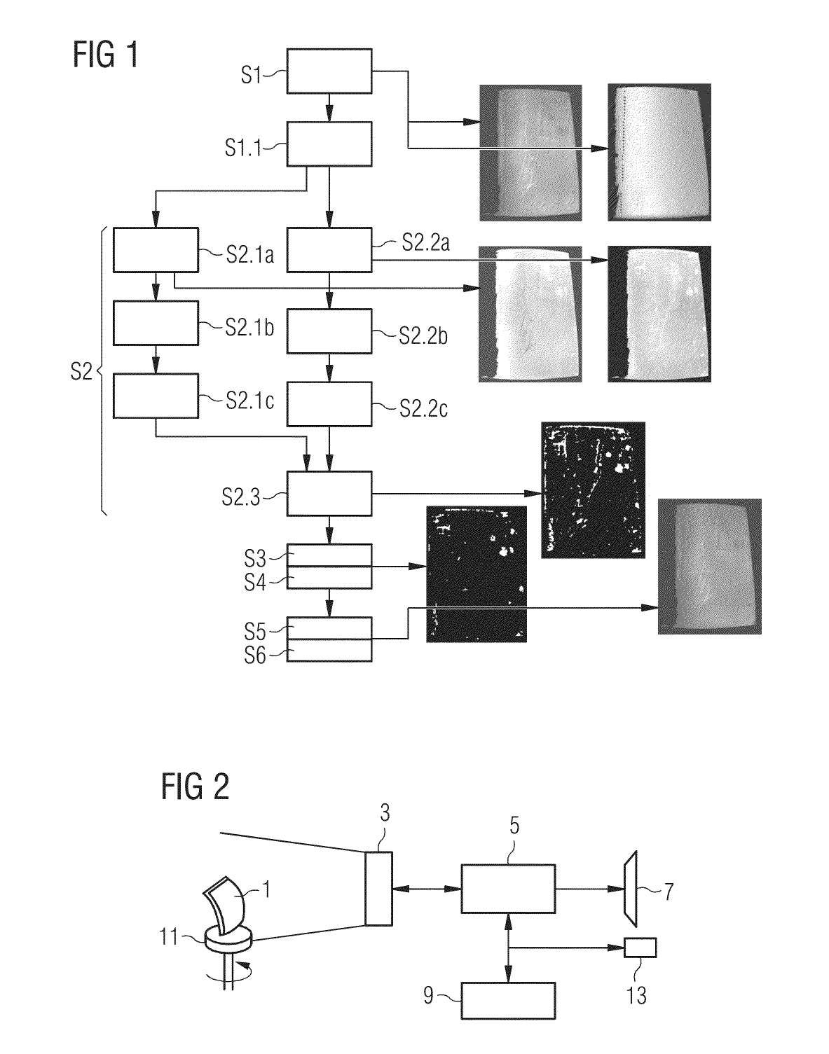

FIG. 1 shows an exemplary embodiment of a method according to the invention. By means of the method it is aimed to inspect an object in terms of defective surface regions. At a step S1, the surface of the object is surveyed and two-dimensional image data of the object and measured surface profiles of the object are generated. In addition, further intrinsic or extrinsic data from other data sources relating to the object can be used for the survey. At a further step S1.1, the background of the object can be masked out during a search for defects by means of the distance data in the three-dimensional information. Toward that end data outside of a cylinder around the object can be deleted. The steps of a method according to the invention apply to all views onto the object. Basically, the objects can be surveyed from all sides. At a following step S2, the two-dimensional image data is evaluated in order to identify potentially defective surface regions. Two-dimensional data of said kind can be processed by means of different filter operations in such a way that candidates for surface damage, in particular for TBC loss, are identified in specific surface regions. According to this exemplary embodiment the red channel is analyzed in a step S2.1 and the saturation is analyzed in a step S2.2. The subsidiary steps for the analysis of the red channel can be for example a step S2.1a, in which red channel information is taken from the source image and inverted. At a step S2.1b, image elements having an excessively great red value are deleted. At a step S2.1c, a locally adjustable threshold value is used. Alternatively or cumulatively, saturation data from a source image in the HSV color space can be obtained and inverted. At a following step S2.2d, image elements having an excessively high saturation value are deleted, a locally adjustable threshold value being resorted to for said filtering according to a step S2.2c. The results from both analyses of steps S2.1 and S2.2 are combined as what are termed masks, in which case, in a step S2.3, the masks can be processed in addition using morphological operators characterizing the morphology of the object in order to identify potentially defective surface regions. This is followed by a step S3, in which surface profiles of the potentially defective surface region are calculated in the boundary zone of the potentially defective surface region on the basis of measured surface profiles. Then follows a step S4, in which the measured and the calculated surface profiles for the potentially defective surface region are compared with one another, the localized surface region being assessed as actually defective if differences are present. At a step S5, a result image can be generated in which the surface regions assessed as actually defective are indicated as surrounded by boundary lines. At a step S6, the result data of the inspected object can be stored for documentation purposes.

FIG. 2 shows an exemplary embodiment of a device according to the invention. An object 1 is to be examined in respect of its surface condition. For example, the object 1 is rotated by means of a turntable 11, embodied for example as a rotary plate, in the detection range of a scanning device 3. In this case the rotation can be executed at least once around the axis, in particular the longitudinal axis, of the object 1 itself. The scanning device 3 supplies corresponding image data to a computer device 5. The latter processes this two-dimensional and three-dimensional information about the object 1 acquired by the scanning device 3 further and stores the results in a storage device 9. In addition the computer device 5 can be used to make result images visible for an inspection operative by means of a display device 7. The inspection operative can control the computer device 5 and the scanning device 3 by means of an interface 13, which can be for example a mouse or a keyboard. Controlling the rotary plate 11 is possible in addition. In the case of a turbine blade the blade that is to be inspected is surveyed by means of a scanner which for example is part of a system referred to as a global inspection system. In this way a two-dimensional image and a three-dimensional model of the object 1 can be generated which are calibrated with respect to one another such that both sets of information are assigned to precisely one point or the same region of the surface of the object. The two-dimensional images can be grayscale images, though equally color images, in which latter case further information is produced. Image data or object data is generated from all sides of the object by moving the object 1 by means of a rotary plate 11 and repeated recording. The two-dimensional data is processed by means of a variety of filter operations in such a way that potentially defective surface regions, i.e. candidates for TBC loss in specific regions, can be detected. Examples of filter operations are the analysis of a color channel, particularly advantageously the red channel for example, and of the saturation, in which delaminations can be represented in a particularly high-contrast manner as dark. Other filter operations are also possible in principle. An interpolation of a blade surface based on the environment of the candidates can be carried out by means of the link with the surface profiles in the three-dimensional model. If the interpolated values are now compared with the originally measured values at the relevant locations, it will emerge whether a surface defect, for example in the form of TBC loss, or mere soiling, in particular of a blade, is actually present.

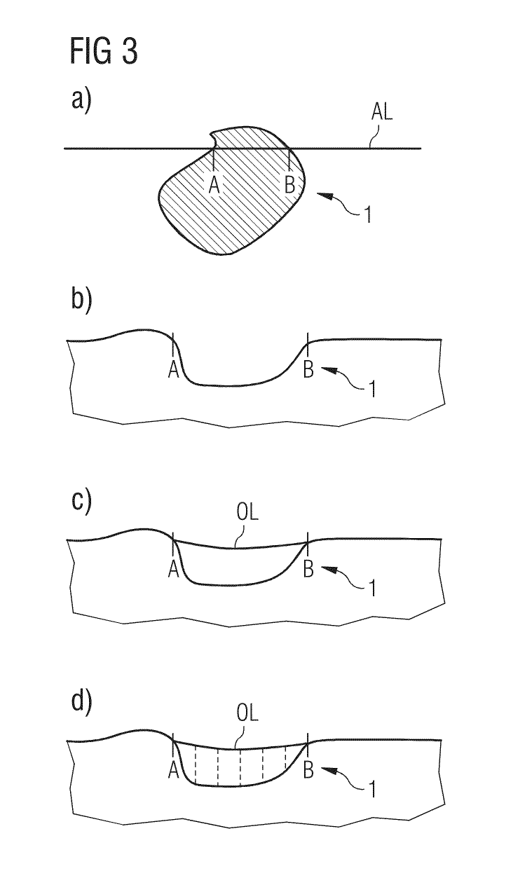

FIGS. 3a to 3d show the steps of a method according to the invention as a representation of a plan view onto a potentially defective surface region of an object 1, with an associated cross-section along a scan line AL. By means of the steps represented in FIGS. 3a to 3d it is possible, using the three-dimensional data, to infer whether a defect indication, based on a two-dimensional image according to FIG. 3a, is actually surface damage, for example TBC loss. FIG. 3a shows a plan view onto a surface region of an object. On the basis of the two-dimensional image data a potentially defective surface region has been localized, this being represented as dark in FIG. 3a. Said dark region is encompassed by a bright surface region, the boundary zone of the potentially defective surface region. The straight line in FIG. 3a is a scan line AL of a scanner or scanning device, the section between points A and B being assigned to the potentially defective surface region and the regions to the left of point A and to the right of point B being assigned to the boundary zone of the potentially defective surface region. The scan line AL can equally be referred to as a section of an image line. The scanning device can be used to measure surface data along the scan line in at least one cross-sectional plane of the object in each case. The complete surface profile data of the overall object can already be present in its entirety at the beginning of a method. Said surface profile data can then be examined more precisely to identify a potentially defective surface region. It is also possible to acquire the surface profile data for the region of interest and/or its environment only as and when required. FIG. 3b now shows the cross-section of the surface region that is to be inspected. In this case the scan line is shown in cross-section and reveals the three-dimensional view of the measured surface of the object 1 that is to be inspected. Between points A and B the object has a measured surface profile which is visualized by means of the curve in FIG. 3b. FIG. 3c now shows how a surface profile of the potentially defective surface region is calculated in addition on the basis of the measured surface profile in the boundary zone of the potentially defective surface region. In other words, starting from the curve shape to the left of point A and to the right of point B in the cross-section of FIG. 3c, an intact surface profile is calculated between points A and B. This constitutes the upper line OL between points A and B in FIG. 3c. FIG. 3d shows that the measured and the calculated surface profiles are now compared, the localized surface region, i.e. the dark area in FIG. 3a, being assessed as actually defective if defined features, for example significant differences, are present. A defined feature can be for example a correlation between upper and lower curve shape. The difference between the originally measured and the interpolated three-dimensional data can determine whether for example a TBC loss is present in the case of an indication in the two-dimensional and three-dimensional data, or simply a dark point with an indication in the two-dimensional data only.

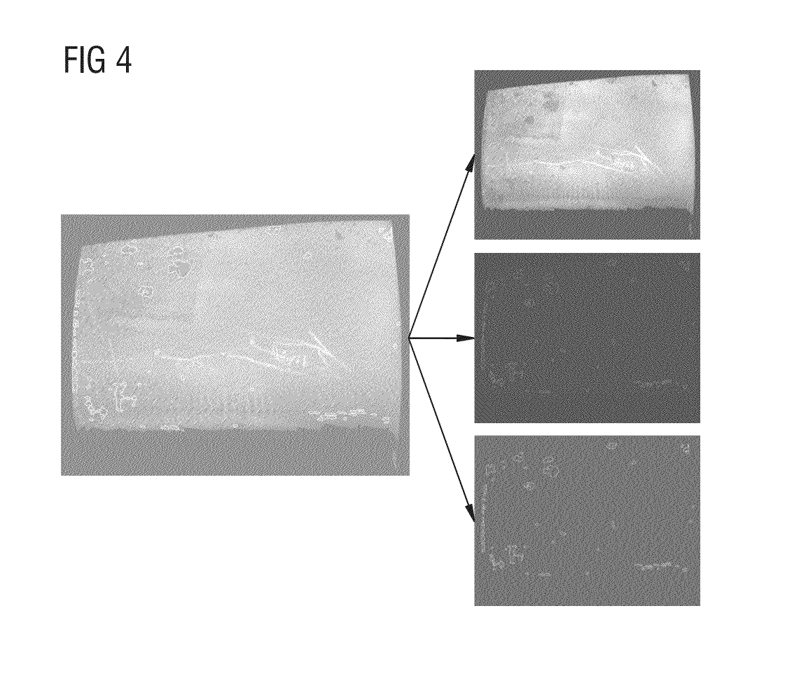

FIG. 4 shows an exemplary embodiment of a result image, as well as a further processing operation on the result image. A result image with boundary lines around surface regions assessed as actually defective can be processed further according to the invention. For example, FIG. 4 shows a subdivision of the original image arranged on the left-hand side into three images arranged on the right-hand side, once in a red channel, in a green channel and in a blue channel. In this case the information in the red channel can provide surface information for easier visual inspections. Information in the green channel is suitable for use in coding different display or indication types. Information about the filters or masks can be displayed in the blue channel. FIG. 4 shows an original result image on the left, a red channel image at top right, a green channel image at center right, and a blue channel image at bottom right.

FIG. 5 shows an exemplary embodiment of a result image of a method according to the invention. The automatic inspection is able to evaluate two-dimensional and three-dimensional object data in a large range of viewing angles.

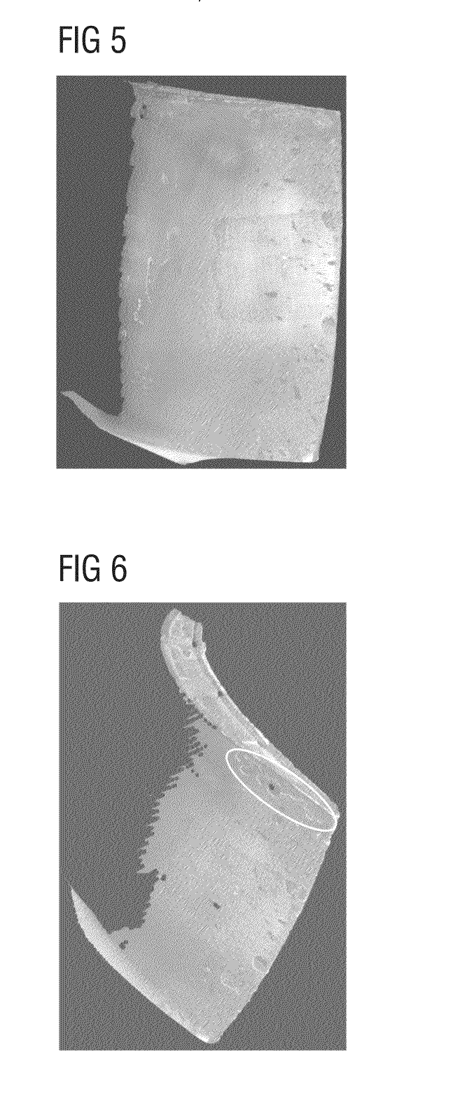

FIG. 6 shows another exemplary embodiment of an inventive result image of a method according to the invention. FIG. 6 shows that not all two-dimensional and three-dimensional measurement data can be used for all viewing angles of the scanning device in order to identify defect locations. That is to say that a TBC loss cannot always be discovered in every view. Every surface defect, in particular TBC loss, ought to be found under at least one viewing angle of the scanning device. FIG. 6 shows that the TBC loss in the circled region was not discovered from this view. The method according to the invention operates particularly advantageously at right viewing angles. Viewing angles at which beams of the scanning device are incident on an average substantially vertically on the surface of the object that is to be examined are particularly advantageous. For example, scanning a turbine blade once in each case from the pressure side and the suction side is sufficient for a majority of the defects, i.e. already two images can advantageously be used particularly easily. According to another advantageous embodiment the inspected actually defective surface regions can be marked by means of boundary lines. Said marking can be carried out by means of a computer device or by printing the boundary lines onto corresponding result images.

1-12. (canceled)

13. A method for inspecting an object for the purpose of detecting defective surface regions of the object, the method comprising the steps of:
using a scanning device to survey a surface of the object to be inspected and generating two-dimensional image data and a measured surface profile in at least one cross-sectional plane through the object in each case;
using a computer device to evaluate the two-dimensional image data in order to localize a potentially defective surface region;
using the computer device to generate a calculated surface profile within the potentially defective surface region in the cross-sectional plane on the basis of the measured surface profile outside of the potentially defective surface region of the cross-sectional plane;
using the computer device to compare the calculated and measured surface profiles within the potentially defective surface region, the localized surface region being assessed as actually defective if defined differentiating features are present.

14. The method as claimed in claim 13 further comprising, the two-dimensional image data and the measured surface profiles of the object are calibrated with respect to one another.

15. The method as claimed in claim 13 further comprising, the two-dimensional image data is color images.

16. The method as claimed in claim 13 further comprising, the two-dimensional image data is evaluated via a filter operations.

17. The method as claimed in claim 16 further comprising, where one filter operation is an analysis of a color channel and a saturation.

18. The method as claimed in claim 16 further comprising, where one filter operation is an analysis of a color channel or a saturation.

19. The method as claimed in claim 13 further comprising, wherein the calculated surface profiles of the potentially defective surface region are generated by means of interpolation.

20. The method as claimed in on claim 13 further comprising,
Wherein the interpolation is carried out along a scan line in the cross-sectional plane through the potentially defective surface region and on the basis of measured surface profiles along the scan line in the cross-sectional plane in the boundary zone of the potentially defective surface region.

21. The method as claimed in claim 13 further comprising, boundary lines around surface regions assessed as actually defective are visualized via a display device.

22. The method as claimed in claim 13 further comprising, wherein the data of the inspected object is stored via a storage device.

23. The method as claimed in claim 13 further comprising, wherein the computer device used to remove data of an object background performs this function via the measured surface profiles.

24. The method as claimed in claim 13 further comprising, wherein the scanning device used to repeatedly record the surface of the entire object is moved via a rotating and swiveling unit (11).

25. The method as claimed in claim 13 further comprising, wherein the scanning device used to repeatedly record the surface of the entire object is moved via a rotating or swiveling unit (11).

26. A device for performing an inspection of an object for the purpose of detecting defective surface regions of the object, comprising:
a scanning device for surveying a surface of the object that is to be inspected and generating two-dimensional image data and a measured surface profile in at least one cross-sectional plane through the object in each case;
a computer device for evaluating the two-dimensional image data in order to localize a potentially defective surface region;
the computer device for generating a calculated surface profile within the potentially defective surface region in the cross-sectional plane on the basis of the measured surface profile outside of the potentially defective surface region of the cross-sectional plane;
the computer device for comparing the calculated and the measured surface profiles within the potentially defective surface region, the localized surface region being assessed as actually defective if defined differentiating features are present.
